(19) United States
(12) Patent Application Publication
(10) Pub. No.: US 2019/0193872 A1
(43) Pub. Date: Jun. 27, 2019

(54) Modular System For Installing Modules On A Fuselage Structure Of A Vehicle

(71) Applicant: Airbus Operations GmbH, Hamburg (DE)

(72) Inventors: Hermann Benthien, Hamburg (DE); Martin Metten, Hamburg (DE); Florian Müller, Hamburg (DE); Michael Telkamp, Hamburg (DE); Marcus Hinrichs, Hamburg (DE); Tancredi Tincani, Hamburg (DE); Ralph Schmitt, Hamburg (DE)

(73) Assignee: Airbus Operations GmbH, Hamburg (DE)

(21) Appl. No.: 16/205,504

(22) Filed: Nov. 30, 2018

(30) Foreign Application Priority Data
Dec. 22, 2017 (DE) 10 2017 131 150.5

(51) Int. Cl. B64F 5/10; B64C 1/06

(52) U.S. Cl. CPC B64F 5/10; B64C 1/069

(57) ABSTRACT

A system for installing modules on a fuselage structure has modules with holders arranged thereon for fastening on a fuselage structure, assembly stands, which can be moved on a floor level, and a flexible connecting element, extending via all the modules and coupling them together. Each assembly stand has a base for supporting the stand on the floor level and a holding device, designed to support the module. The assembly stands, the modules and the at least one connecting element are designed to form a chain of assembly stands, such that two successive groups of assembly stands enclose a pivot point at which the mutually facing modules have a larger spacing relative to one another than the modules within the respective groups. The connecting element allows the pivoting of the groups relative to one another at the pivot point through an angle of at least 90°.

### FIELD OF THE INVENTION

The invention relates to a modular system for installing modules on a fuselage structure of a vehicle and to a method for installing modules on a fuselage structure of a vehicle.

### BACKGROUND OF THE INVENTION

In an aircraft which has a fuselage, there is usually a passenger cabin with a multiplicity of items of equipment. For this purpose, the fuselage, which is built up by means of the fuselage structure, is provided on the inside with a multiplicity of holders, which are matched individually to the items of equipment to be held and ensure the secure mounting of said items of equipment at a predetermined location. In the case of aircraft and especially relatively large passenger aircraft with fuselage lengths of well over 10 m, certain manufacturing tolerances must always be expected, and these must be taken into account in the arrangement of holders. While items of equipment in the fuselage should comply with a clearly predetermined geometry, the individual holders must be adapted to compensate for the production tolerances of the fuselage structure. For example, any undulation in a line or surface formed by several overhead storage bins should be restricted to a significantly greater extent than, for example, dimensional tolerances of the fuselage structure.

The installation of individual modules and the compensation of tolerances, in particular for adaptation of the visible contours in the interior of a cabin of an aircraft, is laborious and, in addition to mechanical connection, also includes connection by electric or other lines. This obstructs the cabin and can prevent other work in the cabin.

### BRIEF SUMMARY OF THE INVENTION

It can be very advantageous to achieve simplified assembly within a vehicle without obstructing the interior of the vehicle for an extended period and thus delaying other work.

An aspect of the invention may create an installation system for components in a vehicle which can be carried out as quickly, accurately and conveniently as possible.

A modular system for installing modules on a fuselage structure of a vehicle is proposed. The modular system has a plurality of modules with holders arranged thereon for fastening on a fuselage structure, a plurality of assembly stands, which can be moved on a floor level, and at least one connecting element, which is flexible at least in some region or regions, extends via all the modules and couples them together in a state in which they are installed on the fuselage structure. Each assembly stand has a base for supporting the assembly stand on the floor level and at least one holding device spaced apart from the base, which is designed to support one of the modules. The assembly stands, the modules and the at least one connecting element are designed to form a chain of assembly stands, with modules arranged thereon and connected together ready for use, in such a way that at least two successive groups of assembly stands enclose a pivot point at which the mutually facing modules have a larger spacing relative to one another than the modules within the respective groups, and wherein the at least one connecting element is designed to allow the pivoting of the groups of assembly stands relative to one another at the pivot point through an angle of at least 90° on the floor level.

Consequently, the modular system according to the invention is an advantageous combination of a plurality of modules to be installed and of a plurality of assembly stands, which can be fitted with the modules to be installed. Particular advantages can be achieved through the interaction between the assembly stands and the modules. These consist especially in that a plurality of assembly stands, which can be arranged in a row, can be fitted with modules to be installed. These modules can be interlinked ready for use on the assembly stands by means of the at least one connecting element. The fitting of the assembly stands can be compared with a fitting operation on the fuselage structure since the modules can be subjected to a function test directly on the assembly stands before the totality consisting of all the interlinked assembly stands is moved into the vehicle in order to actually carry out installation of the modules on the fuselage structure. Consequently, the arrangement and interlinking of the individual modules does not require their presence within the vehicle, thereby making it possible to perform complex work processes for the assembly of the modules, the interlinking thereof and the function test, which take up a certain time, outside the vehicle.

In this context, it should be mentioned that modules can be implemented in many different ways in order subsequently to carry out installation on the fuselage structure. Modules which are coupled to one another by electric and/or pneumatic lines are suitable as a particularly preferred option. These are especially modules which are to be arranged in an overhead zone in a passenger cabin.

In addition to shifting preparatory work outside the vehicle, it is also possible with the modular system according to the invention to achieve the advantage that even narrow spaces are accessible with a chain of assembly stands carrying modules interconnected ready for use. This takes account of the fact that there is often only restricted space available for moving or manoeuvring a chain of assembly stands in an assembly shop while, at the same time, the space available for moving a chain of assembly stands into the vehicle is limited. The possible pivotability of at least two groups of assembly stands through at least 90° enables the assembly stands to be moved within a relatively narrow space, irrespective of the total length of the chain of assembly stands.

The following example may serve to explain this in different words. The vehicle to be fitted can be a passenger aircraft. During fitting, part of the fuselage can be open on one side, or at least one door opening is available. Assuming there is a fuselage open on one side, this can usually be accessed by means of a kind of bridge extending transversely in front of the opening in the fuselage. In this context, “transversely” means that the bridge can be arranged substantially perpendicularly to the longitudinal axis of the fuselage. In the case of equipment installation in the manner customary in the prior art, individual components of limited dimensions are moved by hand or by means of individual movement aids across the bridge into the aircraft fuselage. The respective component is then connected to the fuselage structure and appropriately aligned by hand. According to the invention, however, a whole chain of assembly stands can be provided, which are transported along the bridge to the aircraft fuselage. Since the bridge has a finite width, which is approximately 5 m, it is expedient to introduce several groups of assembly stands successively into the aircraft fuselage. By virtue of the pivotability through at least 90°, it is thus possible for one group of assembly stands to still be standing on the bridge while another group is already positioned within or being introduced into the aircraft fuselage.

The pivot point which is enclosed by the at least two successive groups is situated in a relatively large spacing between two successive assembly stands belonging to two successive groups of assembly stands. Depending on the type of vehicle which is being fitted with the modular system according to the invention, it may not be possible to make a free choice of such a location, that is to say a gap with a pivot point arranged therein. In the context of the above description, it is clear that the connection of the modules to one another ready for use is maintained even over this gap. This gap can therefore be associated, for instance, with a door region of the vehicle fuselage, in which none of the said modules is to be arranged but a connection by means of the at least one connecting element is to be maintained. Here, the spacings between the door regions of a vehicle for passenger transport are not infinitely variable but are determined by applicable directives for evacuation in the case of an unforeseen event. In combination with a conventional length of a module for installation in an aircraft, a particular configuration of the assembly stands, of the modules and of the spacings of the abovementioned gap can therefore be defined.

The connection between the individual assembly stands can be accomplished by mechanical couplings. These should be capable of also allowing slight pivoting movements to move through curves. A connection between two groups of assembly stands which enclose the pivot point can be accomplished by specially adapted elongate coupling devices. These can furthermore also protect the at least one connecting element extending across the gap by surrounding it with a kind of cage or grille. The elongate coupling device can preferably determine the pivoting radius at the pivot point.

In summary, the modular system according to the invention allows particularly advantageous manufacture of equipment components for a vehicle cabin, enabling adaptation work to be shifted outside a vehicle fuselage and thereby allowing more efficient assembly. Moreover, adaptation of the modules and of the assembly stands which carry them enables an interlinked group of modules to be prepared outside the fuselage, even in the case of restricted space conditions.

In an advantageous embodiment of the invention, the at least one flexible connecting element is an electric and/or pneumatic connecting line between two modules. To obtain the modules and the modular system according to the invention, the modules can tend to have an adapted configuration. In this, care can be taken, in particular, to ensure that desired bending radii or pivoting radii can be achieved more easily by appropriate positioning of the corresponding connecting lines. If there is a plurality of connecting lines, these should if possible be readily deformable about the same pivoting axis. If possible, they should furthermore have the same spacing with respect to the pivoting axis when the modules are on the holding devices.

In an advantageous embodiment, each assembly stand has at least one pivoting device, which can be pivoted about a horizontal pivoting axis around a vertical frame of the assembly stand. The pivoting device can, for instance, have a pivoting arm, which can be pivoted out of a substantially vertical position into a substantially horizontal position. By means of the pivoting device, a module hung on the assembly stand can be pivoted into an envisaged position and then installed after the assembly stand has been positioned on the fuselage structure. In particular, the pivoting device can be lockable, so that, after the movement of the pivoting device, the module position then provided allows simple fastening of said module.

It is advantageous if the base of each of the assembly stands is designed to be brought into contact with at least one fixed point on the floor level and to adjust at least the vertical distance of the holding device from the fixed point. In the case of a chain of assembly stands which carry the modules to be installed and are positioned on the fuselage structure, it is thereby possible to ensure that the initial positions are so precise that very accurate positions of the modules are defined even during the process of installation. A fixed point of this kind can be provided by certain already installed devices. The floor rails in a cabin may be mentioned here by way of example.

As a particular preference, the holders of each module are designed to fix a variable distance of the module or of a component of the module from the fuselage structure. One particular advantage consists in the fact that the individual modules can be fitted with tolerance compensating devices or can be fastened by means of tolerance-compensating holders, which particularly simplify assembly with this modular system. Since the fuselage structure has a certain manufacturing tolerance, which can lead to an unsatisfactory tolerance in assembly positions within the fuselage structure, the modules to be installed should be moved into their envisaged end positions. Since the assembly stands can easily reach the envisaged end positions through precise positioning in the fuselage structure, they merely have to be fixed in these positions. By means of tolerance-compensating holders or similar measures, the modules can be fastened very easily on the fuselage structure and maintain individual spacings with respect to the fuselage structure, starting from their precise starting positions on the assembly stands.

As a particular preference, the at least one connecting element is designed to allow the pivoting of the groups of assembly stands relative to one another at the pivot point through an angle of 180° on the floor level. It is thereby possible to ensure nesting of the individual groups and the parallel arrangement of said groups relative to one another. The chain of assembly stands thus compacted can be manoeuvred more easily over a limited area of action. The 180° pivotability can furthermore simplify the introduction of the chain into the fuselage structure since flexible and ample pivoting of the groups relative to one another allows successive introduction of the groups, even where there is very little available space.

In a particularly advantageous embodiment, the modules and the at least one connecting element are designed in such a way that a radius of curvature of 1 m or less can be achieved at the pivot point. It is thereby possible to arrange two groups of assembly stands close together with modules installed thereon. In particular, it is readily possible to move through very tight curves to introduce a chain of assembly stands into a vehicle fuselage with a limited area of action.

In an advantageous embodiment, the individual modules have a length of 1.5 to 3 m. This necessarily dictates the lengths of the associated assembly stands. A plurality of assembly stands of this kind can be connected together in a chain, and an angle of 90° or 180° can be implemented between at least two adjoining assembly stands. The chain of assembly stands can then be introduced via bridge structures into a vehicle fuselage extending transversely or obliquely thereto if the bridge structure has a width of between 3.5 and 7 m. This has the particular advantage that even a relatively long chain of assembly stands, comprising four or more assembly stands for example, can be pushed easily across a bridge into a vehicle fuselage. As a particular preference, the length of the individual modules is approximately 2 m.

As a particular preference, the modules and the holding devices are designed to enable the modules to be fastened on one side, with the result that they hang down from the holding devices towards the floor level for the fitting of the modules with the at least one connecting element and for the preparation of installation.

At this point, it may be mentioned that the fastening of the modules on the assembly stands is accomplished by means of the holders arranged on the modules, which are used to fasten the modules on the fuselage structure. A plurality of these holders can be arranged on the respective modules and can have a spacing relative to one another which corresponds to associated features of the fuselage structure. For example, a plurality of holders can be distributed in such a way that the spacings thereof relative to one another correspond to the spacings of fuselage frames relative to one another.

As mentioned above, the larger spacing of the at least two successive groups of assembly stands corresponds substantially to a width of a door region of the fuselage structure.

The invention furthermore relates to a method for installing modules on a fuselage structure in a vehicle, having the steps of providing a plurality of assembly stands, which can be moved on a floor level, providing a plurality of modules to be installed with holders arranged thereon, fastening the modules at one side on holding devices of the assembly stands, with the result that the modules hang down from the holding devices towards the floor level, fitting the modules with at least one flexible connecting element, with the result that they are connected to one another ready for use, moving the assembly stands connected to form a chain into a vehicle fuselage, positioning all the assembly stands at envisaged positions in the fuselage structure, pivoting the modules into the envisaged fastening position thereof, and fastening the modules.

The fastening of the modules can comprise fastening a first group of holders, pivoting the modules and fastening a second group of holders. For example, a first group of holders can be formed by the first holders, and the second group of holders can be formed by the second holders. However, this can also be reversed, depending on the design of the modules.

The vehicle fuselage is preferably an aircraft fuselage, wherein the positioning of the assembly stands comprises latching into floor rails in the floor level of the aircraft fuselage. This can be followed by vertical adjustment of the individual assembly stands in order to precisely position the holding devices thereof.

### BRIEF DESCRIPTION OF THE DRAWINGS

Further features, advantages and possible uses of the present invention will be found in the following description of the embodiment examples and the figures. Here, all the features described and/or depicted, in themselves and in any desired combination, form the subject matter of the invention, even when considered independently of their combination in the individual claims or the dependency references thereof. In the figures, the same reference signs furthermore stand for identical or similar objects.

FIG. 1 shows a side view of a section of a modular system according to the invention.

FIG. 2 shows an assembly stand from FIG. 1 with a pivoting device that has been pivoted up.

FIGS. 3a to 3c show the process of pushing in and aligning assembly stands and modules.

FIGS. 4a to 4d show a fuselage structure with mounting devices arranged thereon for receiving holders of the modules.

FIGS. 5a to 5f and 6a to 6f show the movement of a chain of assembly stands into an aircraft fuselage.

FIG. 7 shows a view of a module with connecting elements arranged thereon.

### DETAILED DESCRIPTION

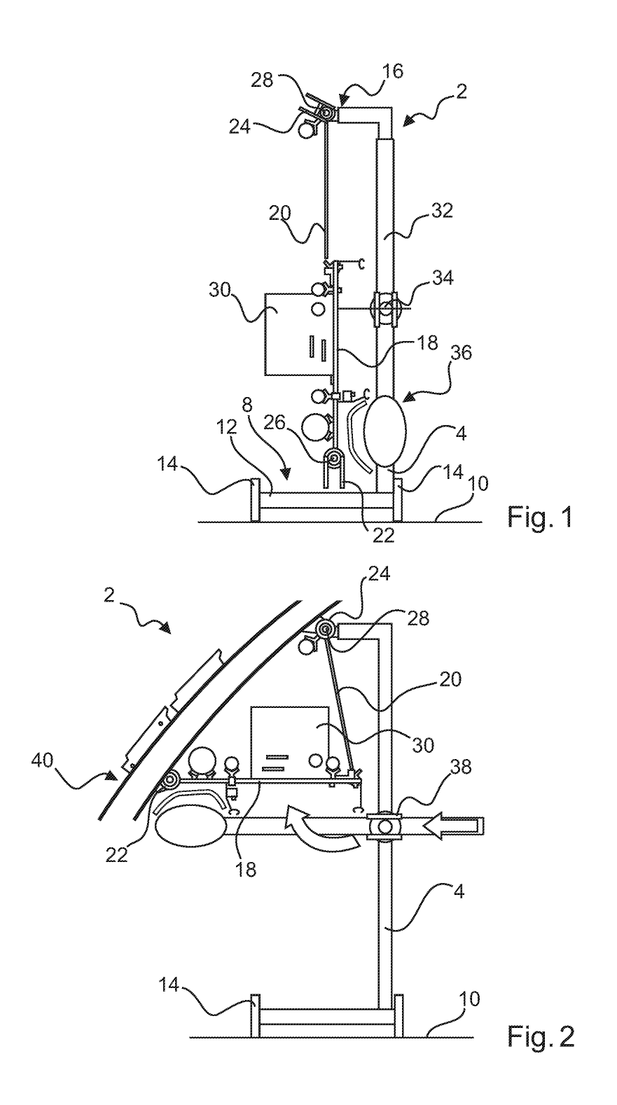

FIG. 1 shows a side view of a section of a modular system 2. Here, an assembly stand 4 and a module 6 to be installed are shown. The assembly stand 4 has a base 8 for supporting the assembly stand 4 on a floor level 10. For this purpose, the base 8 has a base frame 12 with wheels 14 arranged thereon. Consequently, the assembly stand 4 can be moved on the floor level 10 by means of the wheels 14.

Arranged on an opposite side of the assembly stand 4 from the base 8 is a holding device 16, into which the module 6 can be hung. In this context, it may be mentioned that the module 6 has a holding frame 18, holding struts 20, first holders 22 and second holders 24. The first holders 22 are connected to one another by a base body 26. The base body can be embodied as an elongate element, e.g. a tube. This can extend along the longitudinal axis of a fuselage to be fitted with the modules 6. In the same way, the second holders 24 can be connected to one another, in this case by a second base body 28. In the installed state of the modules 6 and of other components that can be mounted thereon, the base bodies 26 and 28 can distribute the load more effectively along the longitudinal direction of the fuselage.

Arranged on the holding frame 18 are components 30 which, by way of example, are to be mounted between an overhead storage bin and a fuselage structure of an aircraft. In the illustration shown in FIG. 1, the holding frame 18 with the system 30 arranged thereon hangs in the direction of the floor level 10 on the holding device 16 via the holding struts 20.

In addition, the assembly stand 4 has a pivoting device 32, which can be pivoted by means of a pivot 34 between the substantially vertical alignment shown in FIG. 1 and a substantially horizontal alignment. A supporting device 36 is in contact at one end of the pivoting device 32 with the holding frame 18, thus allowing the holding frame 18 to rest on the supporting device 36. By means of the pivoting of the pivoting device 32 about the pivot 34, the holding frame 18 is thus pivoted from the vertical position into the horizontal position which the holding frame 18 is intended to adopt after installation.

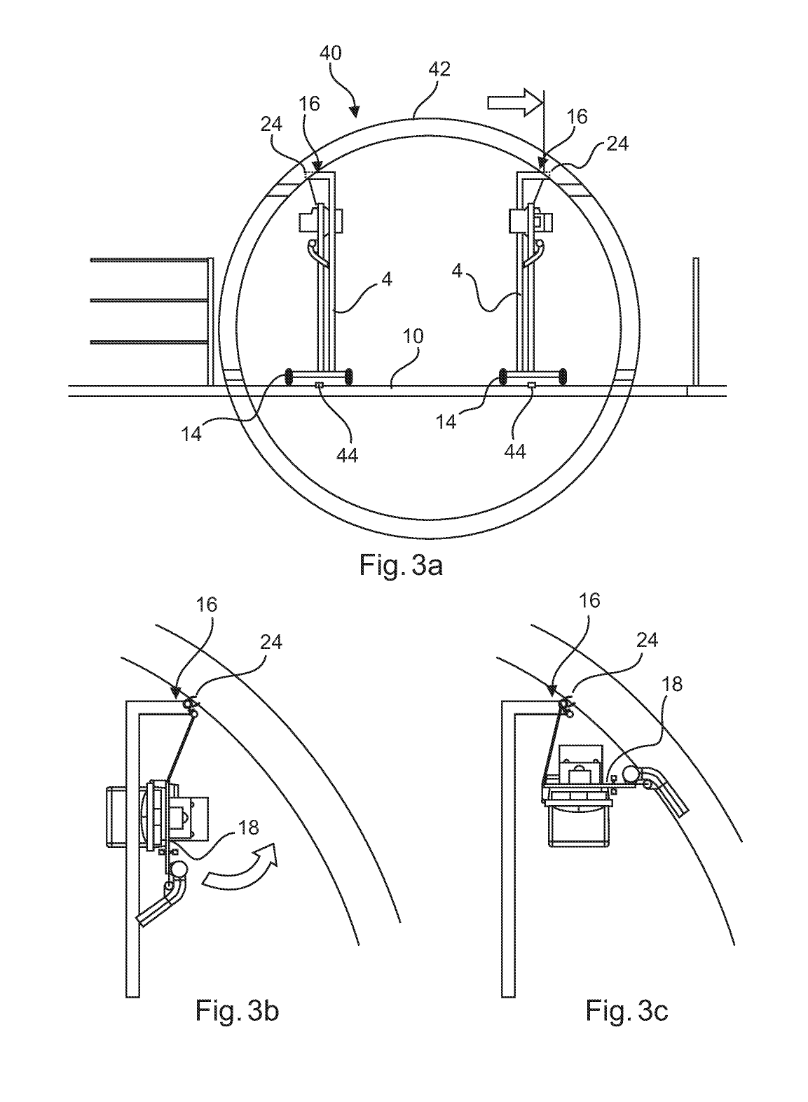

FIG. 2 shows the assembly stand 4 with the pivoting device 32 pivoted up, it being possible, by way of example, to lock the pivoting device in a horizontal position by means of a locking device 38. In this position, the first holders 22 can be connected to a fuselage structure 40. After this or simultaneously, the second holders 24 can be connected to the fuselage structure 40. In the illustration shown, the holding frame 18, together with the holding struts 20 and corresponding attachments on the fuselage structure 40, form a triangular structure. The fastening of the holders 22 and 24 can be interpreted as a preparatory step for the compensation of tolerances of the fuselage structure. The precise position of the holding frame 18 relative to the fuselage structure 40 can be set by means of tolerance compensating devices (not shown).

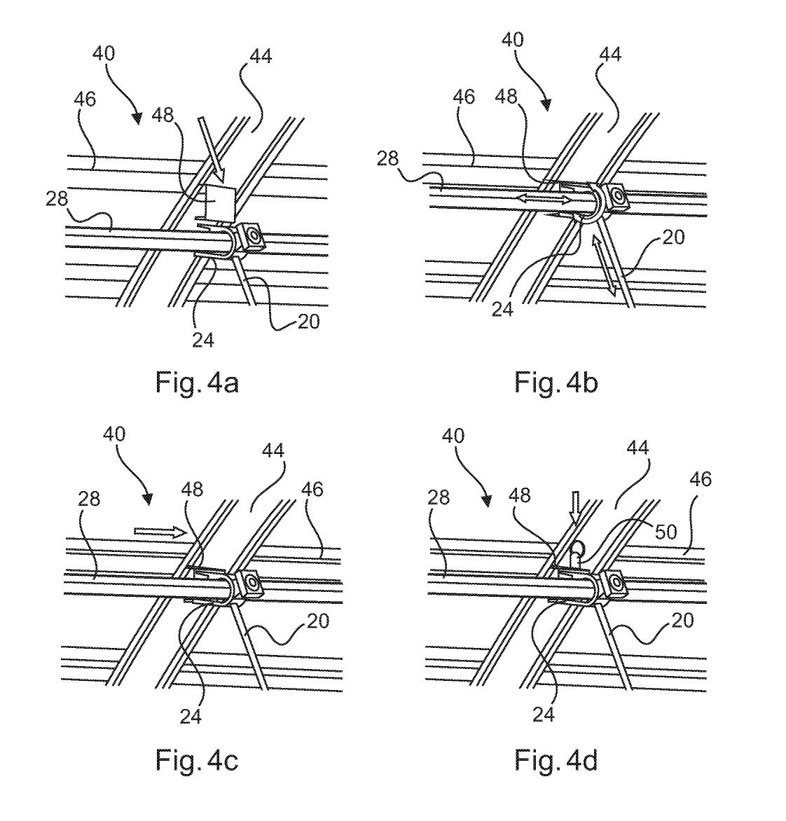

This is illustrated once again schematically in FIGS. 3a to 3c. Here, two assembly stands 4 have been introduced into a vehicle fuselage 42 having a fuselage structure 40. Both stand with their wheels 14 on the floor level 10. The second holders 24 are each moved into position, in which the assembly stands 4 stand in their envisaged positions and set a particular height at the holding devices 16 by means of a setting device (not shown). By way of example, the setting of the assembly stands 4 can be accomplished, in particular, by means of floor rails 44, into which the assembly stands 4 can be latched.

FIGS. 3b and 3c each show the aligned holding device 16 with second holders 24 moved into position, on which the holding frame 18 is pivoted into position.

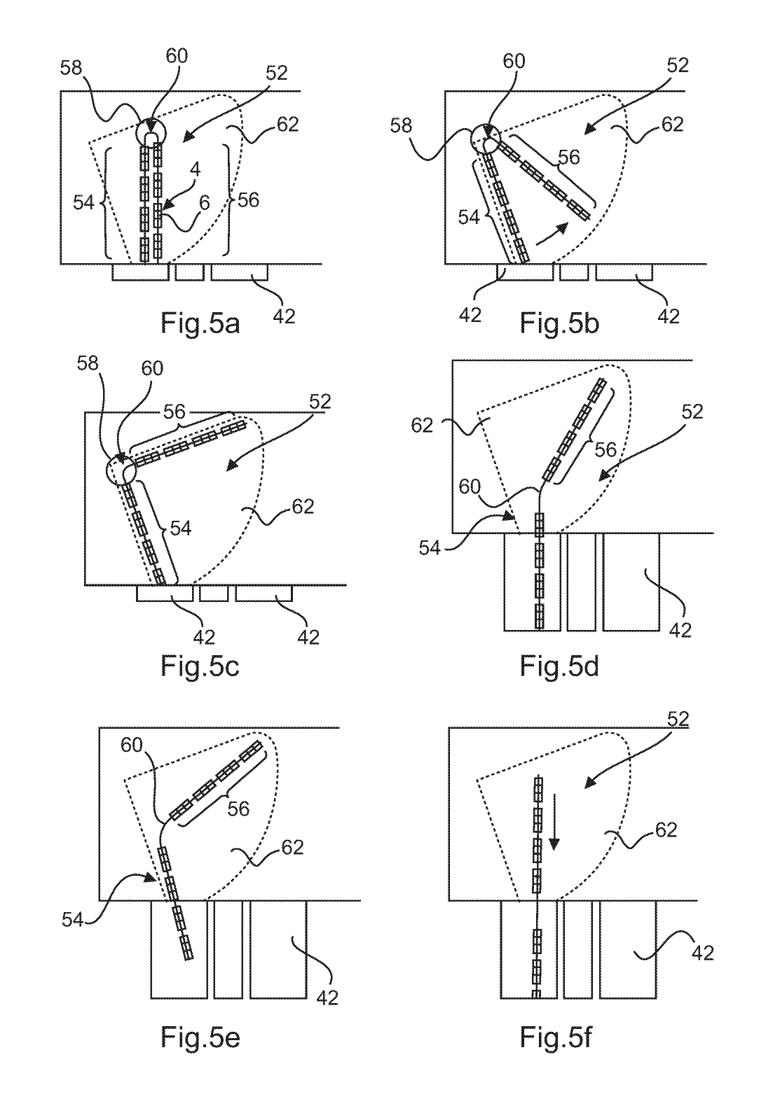

FIGS. 4a to 4d show a fuselage structure 40 with a fuselage frame 44 and stringers 46. A mounting device 48, which is configured to receive the second holder 24, is shown on a fuselage frame. In the successive FIGS. 4a to 4d, the said holder is connected to the mounting device 48 by means of a bolt 50. The second base body 28, which projects through an opening in the first holder 24, is furthermore also illustrated here. The second holder 24 and the second base body 28 are configured to provide a fixed mechanical connection to the second holder 24 in an adjustable manner at a variable position of the second base body 28. It is thereby possible to adjust the position of a plurality of second holders 24 relative to one another.

FIG. 4a shows the second holder 24, which is not quite high enough relative to the mounting device 48. Once the assembly height has been set, the second holder 24 is pushed into the mounting device 48, after which the position of the second base body 28 is set. As can be seen in FIG. 4d, the bolt 50 is then inserted. It is apparent that the holding strut 20 projects from an opening in the first holder 24. This can likewise be fitted with a tolerance compensating device, thus enabling the insertion or screw-in depth of the holding strut 20 into the first holder 24 to be adapted.

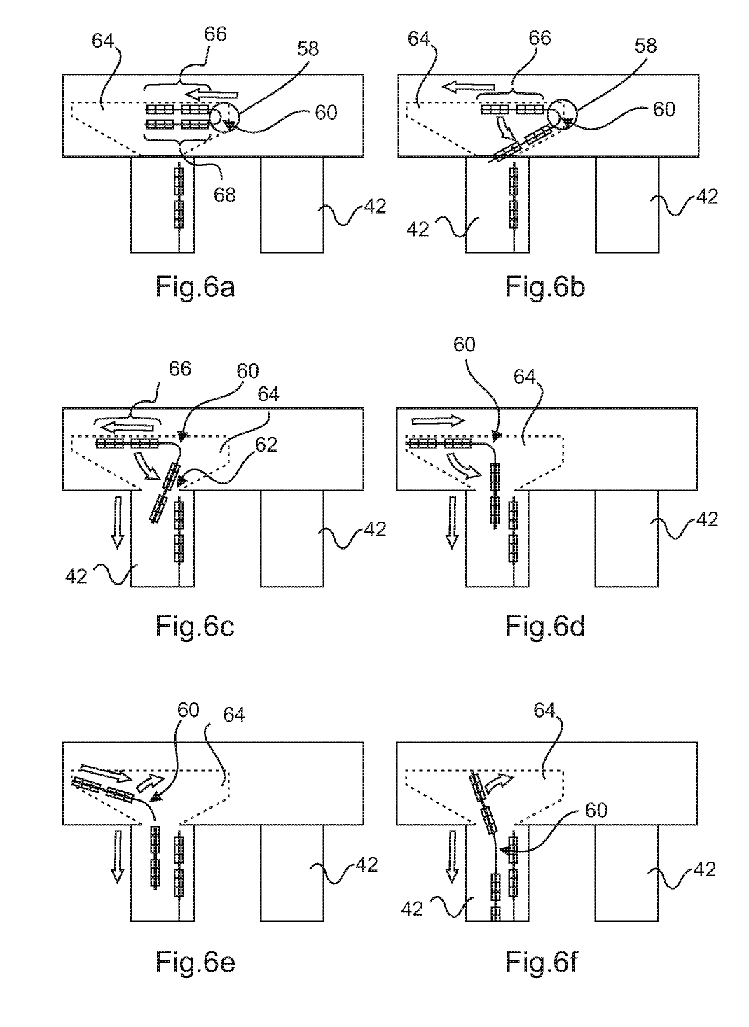

FIGS. 5a to f show the movement of an entire chain 52 of assembly stands 4 with modules 6 arranged thereon for equipping an aircraft fuselage 42 with the modules 6. Here, by way of example, four assembly stands 4 coupled directly to one another are shown, forming a first group 54 of assembly stands 4. A second group is formed by a further four assembly stands 4, this group being denoted by the reference sign 56. Both groups 54 and 56 are pivoted by 180° relative to one another at a pivot point 58. The relevant successive assembly stands 4 are connected to one another here by a pivot joint 60. This ensures that both groups 54 and 56 can be moved adjacently relative to one another and do not damage one another, thus enabling the modules 6 to be mounted on the assembly stands 4 and connected. A further function test after transfer can then be eliminated if satisfactory transfer can be ensured.

A dashed line shows an illustrative zone of action 62, along which the two groups 54 and 56 can be moved. As can be seen in FIG. 5b, the second group of assembly stands 56 can be pivoted up around the pivot point 60, for example, wherein the first group 54 can also be pivoted slightly to the side. After being pivoted up by substantially 90° (FIG. 5C), the first group 54 can already be moved into the aircraft fuselage 42. This is indicated in FIGS. 5d and 5e. Finally, the second group of assembly stands 56 is introduced into the aircraft fuselage 42 in FIG. 5f.

FIGS. 6a to 6f show another example, in which there is a different zone of action 64 and two groups 66 and 68 of assembly stands 4 can be used. While, in FIG. 6A, there are still two groups 66 and 68 of assembly stands 4 arranged parallel to one another, the second group 68 is pivoted up from the first group 66 and introduced into the aircraft fuselage 42 in FIG. 6b. The pivoting and introduction movement is continued in FIG. 6c until, in 6d, there is an angle of approximately 90° between the two groups 66 and 68. After this, the first group 66 is moved further away from the second group 68 until, in FIG. 6f, both groups 66 and 68 extend substantially in one direction and can thus be introduced fully into the aircraft fuselage 42.

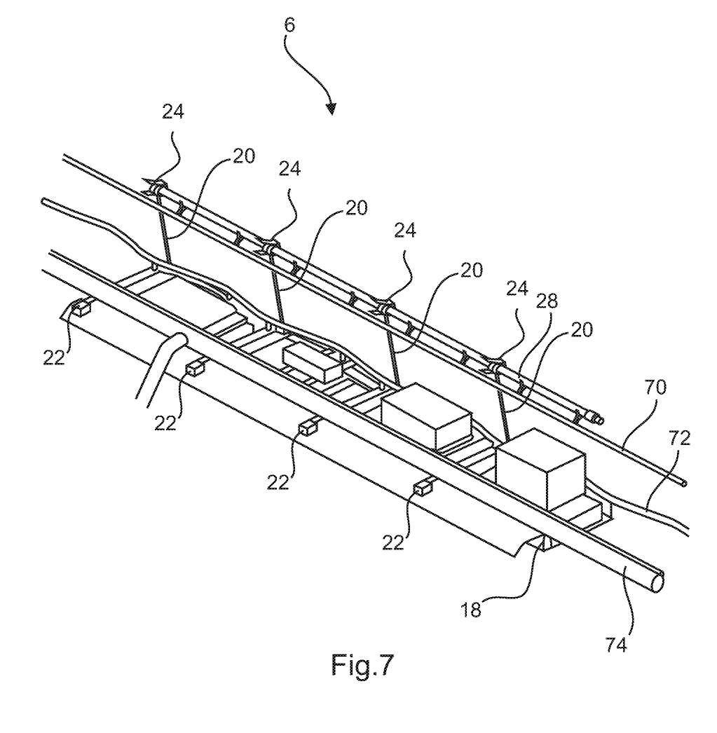

Finally, FIG. 7 shows a view of a module 6 which is fitted with a plurality of holding struts 20, a second base body 28 and a multiplicity of lines 70, 72 and 74 as connecting elements. If, as illustrated in FIGS. 3A to 3C for example, the module 6 is now fastened on an assembly stand 4 by means of the second holder 24, the holding frame 18 hangs down from the holding strut 20. The second base body 28 and the lines 70, 72 and 74 are then all in one plane, which is situated directly below the holding device 28. The position of the holding device 28 and of the couplings between the individual assembly stands 4 can be adapted to one another in such a way that there is as little as possible sagging of the lines 70, 72 and 74 and of the second base body 28 when a chain of a plurality of assembly stands is moved within a workshop. With directly adjoining assembly stands 4, the flexibility of the connecting elements 70, 72 and 74 enables the assembly stands 4 to be pivoted easily relative to one another. If there is a relatively large gap between groups of assembly stands 4, as at the pivot point 58 in FIGS. 5a to 5f, pivoting through up to 180° can be allowed. The lines or connecting elements 70, 72 and 74 must be adapted to this.

For the sake of completeness, it should be noted that “having” does not exclude any other elements or steps and “a” or “an” does not exclude a multiplicity. It should furthermore be noted that features which have been described with reference to one of the above embodiment examples can also be used in combination with other features of other embodiment examples described above. Reference signs in the claims should not be regarded as restrictive.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A modular system for installing modules on a fuselage structure of a vehicle, comprising:
a plurality of modules with holders arranged thereon for fastening on a fuselage structure;
a plurality of assembly stands configured to be moved on a floor level; and
at least one connecting element being flexible at least in some region or regions, extending via all the modules and coupling them together in a state in which they are installed on the fuselage structure,
wherein each assembly stand has a base for supporting the assembly stand on the floor level and at least one holding device spaced apart from the base, configured to support one of the modules,
wherein the assembly stands, the modules and the at least one connecting element are configured to form a chain of assembly stands, with modules arranged thereon and connected together ready for use, in such a way that at least two successive groups of assembly stands enclose a pivot point at which the mutually facing modules have a larger spacing relative to one another than the modules within the respective groups, and
wherein the at least one connecting element is configured to allow the pivoting of the groups of assembly stands relative to one another at the pivot point through an angle of at least 90° on the floor level.

2. The modular system according to claim 1, wherein the at least one flexible connecting element is an electric and/or pneumatic connecting line between two modules.

3. The modular system according to claim 1, wherein the base of each of the assembly stands is configured to be brought into contact with at least one fixed point on the floor level and to adjust at least the vertical distance of the holding device from the fixed point.

4. The modular system according to claim 1, wherein each assembly stand has at least one pivoting device configured to be pivoted about a horizontal pivoting axis around a vertical frame of the assembly stand.

5. The modular system according to claim 1, wherein the holders of each module are configured to fix a variable distance of the module or of a component of the module from the fuselage structure.

6. The modular system according to claim 1, wherein the at least one connecting element is configured to allow the pivoting of the groups of assembly stands relative to one another at the pivot point through an angle of 180° on the floor level.

7. The modular system according to claim 1, wherein the modules and the at least one connecting element are configured in such a way that a radius of curvature of 1 m or less can be achieved at the pivot point.

8. The modular system according to claim 1, wherein the individual modules have a length of 1.5 to 3 m.

9. The modular system according to claim 1, wherein the modules and the holding devices are configured to enable the modules to be fastened on one side, with the result that they hang down from the holding devices towards the floor level for the fitting of the modules with the at least one connecting element and for the preparation of installation.

10. The modular system according to claim 1, wherein the larger spacing of the at least two successive groups of assembly stands corresponds substantially to a width of a door region of the fuselage structure.

11. A method for installing modules on a fuselage structure in a vehicle, comprising:
providing a plurality of assembly stands configured to be moved on a floor level;
providing a plurality of modules to be installed with holders arranged thereon;
fastening the modules at one side on holding devices of the assembly stands, with the result that the modules hang down from the holding devices towards the floor level;
fitting the modules with at least one flexible connecting element, with the result that the modules are connected to one another ready for use;
moving the assembly stands connected to form a chain into a vehicle fuselage;
positioning all the assembly stands at envisaged positions in the fuselage structure;
pivoting the modules into the envisaged fastening position thereof; and
fastening the modules.

12. The method according to claim 11, wherein the fastening of the modules comprises fastening a first group of holders, pivoting the modules and fastening a second group of holders.

13. The method according to claim 11, wherein the vehicle fuselage is an aircraft fuselage and wherein the positioning of the assembly stands comprises latching into floor rails in the floor level of the aircraft fuselage.
